(19) United States
(12) Patent Application Publication
(10) Pub. No.: US 2024/0256886 A1
(43) Pub. Date: Aug. 1, 2024

(54) INFORMATION PROCESSING APPARATUS, INFORMATION PROCESSING METHOD, INFORMATION PROCESSING SYSTEM, AND STORAGE MEDIUM

(71) Applicant: NEC Corporation, Minato-ku, Tokyo (JP)

(72) Inventor: Kei TAKEMURA, Tokyo (JP)

(73) Assignee: NEC Corporation, Minato-ku, Tokyo (JP)

(21) Appl. No.: 18/562,537

(22) PCT Filed: May 26, 2021
(86) PCT No.: PCT/JP2021/020000

§ 371 Date: Nov. 20, 2023

(51) Int. Cl. G06N 3/092

(52) U.S. Cl. CPC G06N 3/092

(57) ABSTRACT

To determine a more suitable action, an information processing apparatus (1) includes: an acquisition unit (11) configured to acquire a state; a determination unit (12) configured to determine an action with reference to the state; and an accumulation unit (13) configured to accumulate learning data including (i) the state and (ii) a reward obtained by the action which has been determined by the determination unit. The determination unit is configured to calculate a first function, which predicts a reward sum from a state and an action, by carrying out weighting for the learning data, and determine the action with use of the first function.

### TECHNICAL FIELD

The present invention relates to an information processing apparatus, an information processing method, an information processing system, and a program all of which determine an action.

### BACKGROUND ART

A technique has been known of, while observing rewards in a state in which a relationship between actions and rewards is unknown, sequentially determining an action that maximizes a sum total of rewards. For example, as an example of such a technique, Non-patent Literature 1 discloses a technique using the so-called Upper-Confidence Bounds (UCB) algorithm.

### CITATION LIST

### Non-Patent Literature

[Non-patent Literature 1] Chi Jin et. al. “Provably Efficient Reinforcement Learning with Linear Function Approximation” arXiv: 1907.05388v2 [cs. LG], Aug. 8, 2019

### SUMMARY OF INVENTION

### Technical Problem

However, the technique described in Non-patent Literature 1 has room for improvement in terms of determining a more suitable action. This is because, with regard to learning data which is referred to in order to determine an action and generally includes high-reliability data and low-reliability data in a mixed manner, the technique of Non-patent Literature 1 treats these data on a par with each other.

An example aspect of the present invention has been made in view of the above problem, and an example of the object is to provide a technique that enables determination of a more suitable action.

### Solution to Problem

An information processing apparatus in accordance with an example aspect of the present invention includes: an acquisition means for acquiring a state; a determination means for determining an action with reference to the state; and an accumulation means for accumulating learning data including (i) the state and (ii) a reward obtained by the action which has been determined by the determination means, the determination means being configured to calculate a first function, which predicts a reward sum from a state and an action, by carrying out weighting for the learning data, and determine the action with use of the first function.

An information processing method in accordance with an example aspect of the present invention includes, in a repeated manner, the steps of: an information processing apparatus acquiring a state; the information processing apparatus determining an action with reference to the state; and the information processing apparatus accumulating learning data including (i) the state and (ii) a reward obtained by the determined action, wherein, in the step of determining the action, the action is determined with use of a first function, the first function predicting a reward sum from a state and an action and being calculated by carrying out weighting for the learning data.

A program in accordance with an example aspect of the present invention is a program causing a computer to function as an information processing apparatus, the program causing the computer to function as: an acquisition means for acquiring a state; a determination means for determining an action with reference to the state; and an accumulation means for accumulating learning data including (i) the state and (ii) a reward obtained by the action which has been determined by the determination means, the determination means being configured to calculate a first function, which predicts a reward sum from a state and an action, by carrying out weighting for the learning data, and determine the action with use of the first function.

An information processing system in accordance with an example aspect of the present invention is an information processing system including an information processing apparatus and a terminal apparatus, wherein the information processing apparatus includes: an acquisition means for acquiring a state; a determination means for determining an action with reference to the state; and an accumulation means for accumulating learning data including (i) the state and (ii) a reward obtained by the action which has been determined by the determination means, the determination means being configured to calculate a first function, which predicts a reward sum from a state and an action, by carrying out weighting for the learning data, and determine the action with use of the first function, and the terminal apparatus includes: a state information provision means for acquiring a state and providing the state to the information processing apparatus; and a reward information provision means for providing, to the information processing apparatus, reward information indicative of a reward obtained by executing an action which has been determined by the information processing apparatus.

An information processing method in accordance with an example aspect of the present invention includes, in a repeated manner, the steps of: an information processing apparatus acquiring a state; the information processing apparatus determining an action with reference to the state; and the information processing apparatus accumulating learning data including (i) the state and (ii) a reward obtained by the determined action, wherein, in the step of determining the action, the action is determined with use of a first function, the first function predicting a reward sum from a state and an action and being calculated by carrying out weighting for the learning data; a terminal device acquiring a state and providing the state to the information processing apparatus; and the terminal device providing, to the information processing apparatus, reward information indicative of a reward obtained by executing an action which has been determined by the information processing apparatus.

### Advantageous Effects of Invention

According to an example aspect of the present invention, it is possible to determine a more suitable action.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information processing method carried out by the information processing apparatus in accordance with the first example embodiment of the present invention.

FIG. 3 is a block diagram illustrating a configuration of an information processing system in accordance with the first example embodiment of the present invention.

FIG. 4 is a flowchart illustrating a flow of an information processing method carried out by the information processing system in accordance with the first example embodiment of the present invention.

FIG. 5 is a block diagram illustrating a configuration of an information processing system in accordance with a second example embodiment of the present invention.

FIG. 6 is a view illustrating examples of various data stored in a storage unit of the information processing apparatus in accordance with the second example embodiment of the present invention.

FIG. 7 is a flowchart illustrating a flow of an information processing method carried out by the information processing apparatus in accordance with the second example embodiment of the present invention.

FIG. 8 is a block diagram illustrating a configuration of an information processing apparatus in accordance with a third example embodiment of the present invention.

FIG. 9 is a view illustrating examples of display screens displayed by the information processing apparatus in accordance with the third example embodiment of the present invention.

FIG. 10 is a block diagram illustrating an example of a hardware configuration of the information processing apparatus in each of the example embodiments of the present invention.

### DESCRIPTION OF EMBODIMENTS

### First Example Embodiment

A first example embodiment of the present invention will be described in detail with reference to the drawings. The present example embodiment is a basic form of an example embodiment described later.

### <Outline of Information Processing Apparatus 1>

In brief, an information processing apparatus 1 in accordance with the present example embodiment is an apparatus that selects an action which maximizes a value of a certain kind of prediction function in a given state. Here, the prediction function is, as an example, a function that calculates a prediction value of a sum of objective amounts. More specifically, the information processing apparatus 1, as an example, sequentially accumulates, as learning data, the following:
a state in the past;
an action selected in the past; and
an observation value of an objective amount obtained by the state in the past and the action selected in the past, and sequentially updates a prediction function that predicts a sum of objective amounts, with reference to the learning data. Here, the information processing apparatus 1 is configured to select an action which maximizes the prediction function in a given state.

In other words, the information processing apparatus 1 is an apparatus that is configured to repeat the following steps:
acquiring a state;
selecting an action which maximizes a prediction function in a state in which the state has been acquired;
acquiring an observation value of an objective amount obtained by the selected action;
accumulating, as learning data, the state, the action, and the observation value of the objective amount; and
updating the prediction function with use of the leaning data.

Note that, as the above-described objective amount, a reward obtained by an action can be taken as an example. In addition, the above-described prediction function can include a reward sum function of calculating a prediction value of a sum of rewards. Here, in the present example embodiment, the “state”, “action”, and “reward” are interpreted as having concepts that do not include any particular limitations in terms of information processing unless otherwise specified.

In addition, the expression “learning data” in the present specification is not intended to be limited to data other than data which is referred to in order to update (learn) a prediction function. The expressions such as “training data”, “teacher data”, and “reference data” may be used in place of the expression “learning data” in the present specification.

### <Configuration of Information Processing Apparatus 1>

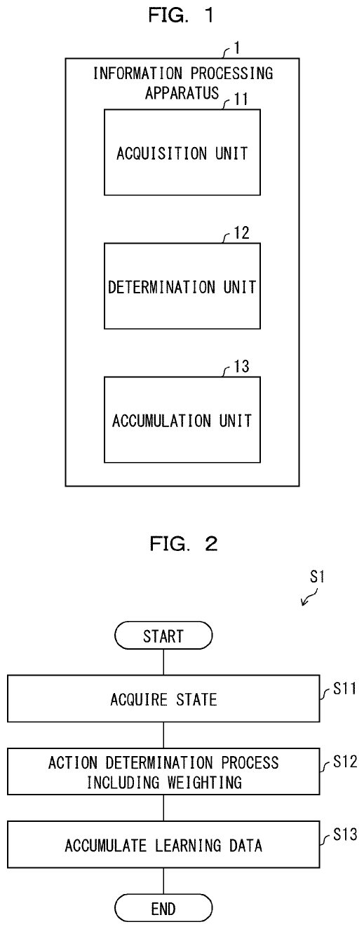

A configuration of the information processing apparatus 1 in accordance with the present example embodiment will be described with reference to FIG. 1. FIG. 1 is a block diagram illustrating the configuration of the information processing apparatus 1.

As illustrated in FIG. 1, the information processing apparatus 1 includes an acquisition unit 11, a determination unit 12, and an accumulation unit 13. The acquisition unit 11 is configured to realize an acquisition means in the present example embodiment. The determination unit 12 is configured to realize a determination means in the present example embodiment. The accumulation unit 13 is configured to realize an accumulation means in the present example embodiment.

The acquisition unit 11 acquires a state. As an example, the acquisition unit 11 acquires state information that includes information pertaining to a state, and identifies the state indicated by the state information. Note here that a specific example of the “state” is not intended to limit the present example embodiment. As an example of the “state”, a state of an environment such as a temperature and a weather condition can be taken.

The determination unit 12 determines an action with reference to the state acquired by the acquisition unit 11. Here, the determination unit 12 calculates a first function, which predicts a reward sum from a state and an action, by carrying out weighting for learning data accumulated by the accumulation unit 13, which will be described later, and determines an action with use of the first function. Here, the first function is a function of predicting a reward sum and thus may also be referred to as a reward sum function. In addition, the first function is also a function of quantifying a value of an action and thus may also be referred to as an action value function.

Further, a specific example of the weighting processing which is carried out for the learning data by the determination unit 12 is not intended to limit the present example embodiment. As an example, the determination unit 12 can calculate the first function by calculating an index related to variability from one or more values included in the learning data and applying a smaller weighting factor to the one or more values as the calculated index related to the variability is higher.

Note here that, as an example, an index that can be used as the index related to the variability is the one that can be interpreted as an index representing the reliability of each value included in the learning data. Further, it can be interpreted that the larger the variability, the lower the reliability. Therefore, the determination unit 12 can also be expressed as the one that calculates the first function by applying a higher weight to a value having higher reliability.

Further, a specific example of the “action” is not intended to limit the present example embodiment. As an example of the “action”, a “price” of a target object, a “purchase amount” thereof, and the like can be taken. Further, a specific example of the “reward” is not intended to limit the present example embodiment. As an example of the “reward”, “sales”, an “inverse of an inventory level”, a “difference obtained by subtracting the inventory level from a constant”, and the like on a target object can be taken.

Note that the determination unit 12 can be configured to select an action that maximizes the first function which includes, as an argument, the state acquired by the acquisition unit 11. However, such a configuration is not intended to limit the present example embodiment.

The accumulation unit 13 accumulates learning data that includes (i) the state which has been acquired by the acquisition unit 11 and (ii) the reward obtained by the action which has been determined by the determination unit 12.

### <Effect of Information Processing Apparatus 1>

According to the information processing apparatus 1 in accordance with the present example embodiment, a first function, which predicts a reward sum from a state and an action, is calculated by carrying out weighting for the learning data, and an action is determined with use of the first function. This makes it possible to determine a more suitable action.

### <Flow of Information Processing Method Carried Out by Information Processing Apparatus 1>

The flow of an information processing method S1 carried out by the information processing apparatus 1 configured as described above will be described with reference to FIG. 2. FIG. 2 is a flowchart illustrating the flow of the information processing method S1. The information processing apparatus 1 repeatedly carries out selection of an action by repeating the information processing method S1. Note that descriptions of the contents that have already been described will be omitted.

As illustrated in FIG. 2, the information processing method S1 includes steps S11 to S13.

### (Step S11)

In step S11, the acquisition unit 11 acquires a state. As an example, the acquisition unit 11 acquires state information that includes information pertaining to a state, and identifies the state indicated by the state information.

### (Step S12)

In step S12, the determination unit 12 determines an action with reference to the state which has been acquired in step S11 by the acquisition unit 11. Here, the determination unit 12 determines the action with use of a first function that predicts a reward sum from a state and an action and that is calculated by carrying out weighting for learning data.

Here, in the n-th (where n is a natural number) iteration, used as the learning data to be referred to by the determination unit 12 to calculate the first function is, as an example, learning data having been accumulated until after the (n-1) th iteration.

### (Step S13)

In step S13, the accumulation unit 13 accumulates learning data that includes (i) the state which has been acquired in step S12 by the acquisition unit 11 and (ii) a reward obtained by the action which has been determined in step S12 by the determination unit 12.

### <Effect of Information Processing Method S1>

According to the information processing method S1 in accordance with the present example embodiment, a first function, which predicts a reward sum from a state and an action, is calculated by carrying out weighting for the learning data, and an action is determined with use of the first function. This makes it possible to determine a more suitable action.

### <Configuration of Information Processing System>

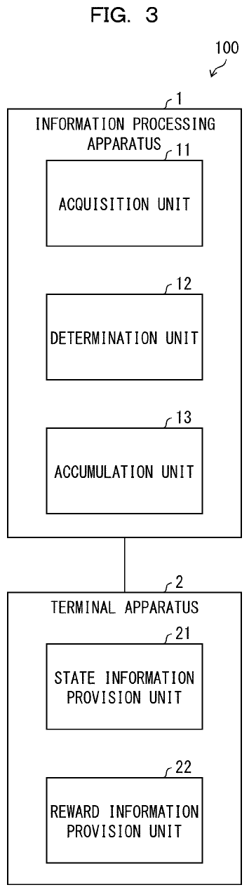

Next, a configuration of an information processing system 100 in accordance with the present example embodiment will be described with reference to FIG. 3. FIG. 3 is a block diagram illustrating the configuration of the information processing system 100.

As illustrated in FIG. 3, the information processing system 100 includes the information processing apparatus 1 and a terminal apparatus 2. Since the components included in the information processing apparatus 1 have already been described, descriptions of the components will be omitted here.

The terminal apparatus 2, as illustrated in FIG. 3, includes a state information provision unit 21 and a reward information provision unit 22. The state information provision unit 21 is configured to realize a state information provision means in the present example embodiment. The reward information provision unit 22 is configured to realize a reward information provision means in the present example embodiment.

The state information provision unit 21 acquires a state and provides the state to the information processing apparatus 1. As an example, the state information provision unit 21 acquires data indicative of a state and provides the data to the information processing apparatus 1.

The reward information provision unit 22 provides, to the information processing apparatus 1, reward information indicative of a reward obtained by executing an action which has been determined by the information processing apparatus 1. The reward information provision unit 22 may be configured, as an example, to include: an acquisition unit that acquires action information indicative of an action which has been determined by the information processing apparatus 1; and an execution unit that executes the action which has been determined by the information processing apparatus 1.

### <Effect of Information Processing System>

According to the information processing system 100 in accordance with the present example embodiment, a first function, which predicts a reward sum from a state and an action, is calculated by carrying out weighting for the learning data, and an action is determined with use of the first function. This makes it possible to determine a more suitable action.

### <Flow of Information Processing Method Carried Out by Information Processing System 100>

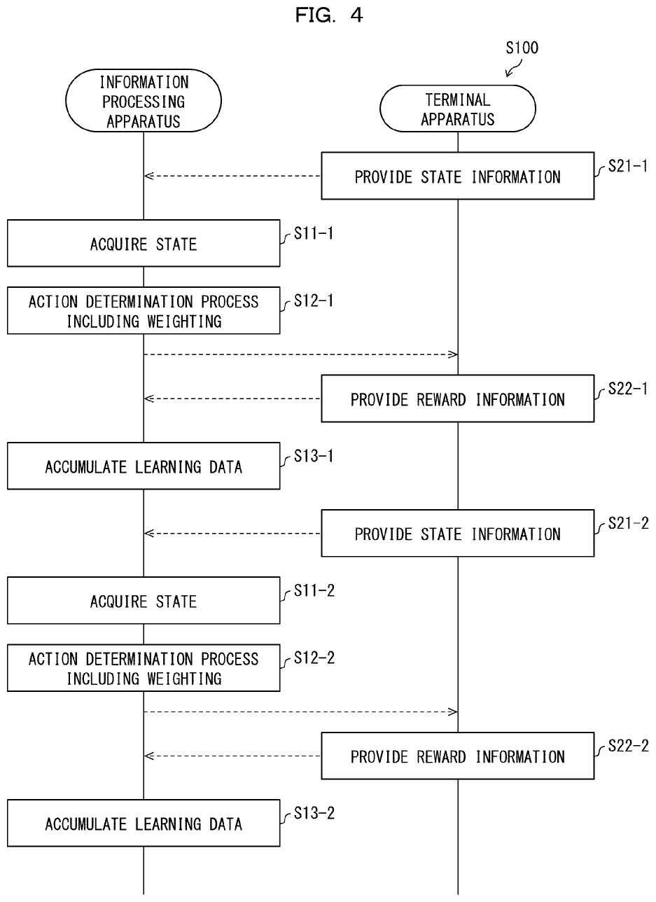

The flow of an information processing method S100 carried out by the information processing system 100 configured as described above will be described with reference to FIG. 4. FIG. 4 is a flowchart illustrating the flow of the information processing method S100. The information processing system 100 repeatedly carries out selection of an action by carrying out the information processing method S100. Note that descriptions of the contents that have already been described will be omitted.

As illustrated in FIG. 4, the information processing method S100 includes steps S11 to S13 and steps S21 and S22 in a repeated manner. Here, with respect to a numeral given to each step in FIG. 4, the order of the iteration is provided as a branch number followed by a hyphen “-”. For example, S21-1 indicates a first iteration, and S21-2 indicates a second iteration. The same applies to the other steps.

### (Step S21-1)

In S21-1, the state information provision unit 21 of the terminal apparatus 2 acquires data indicative of a state and provides the data to the information processing apparatus 1.

### (Step S11-1)

In Step S11-1, the acquisition unit 11 of the information processing apparatus 1 acquires the state which has been provided by the state information provision unit 21 of the terminal apparatus 2.

### (Step S12-1)

In step S12-1, the determination unit 12 of the information processing apparatus 1 determines an action with reference to the state which has been acquired in step S11-1 by the acquisition unit 11. Then, the information processing apparatus 1 provides, to the terminal apparatus 2, action information indicative of the determined action.

### (Step S22-1)

In step S22-1, the reward information provision unit 22 of the terminal apparatus 2 provides, to the information processing apparatus 1, reward information indicative of a reward obtained by executing the action which has been determined in step S12-1 by the determination unit 12 of the information processing apparatus 1.

### (Step S13-1)

In step S13-1, the accumulation unit 13 of the information processing apparatus 1 accumulates learning data that includes (i) the state which has been acquired in step S12-1 by the acquisition unit 11 and (ii) the reward obtained by the action which has been determined in step S12-1 by the determination unit 12.

### (Step S21-2)

Next, in S21-2, the state information provision unit 21 of the terminal apparatus 2 acquires data indicative of a state and provides the data to the information processing apparatus 1. Information obtained in this step can differ from the state which has been acquired in step S21-1.

### (Step S11-2)

In Step S11-1, the acquisition unit 11 of the information processing apparatus 1 acquires the state which has been provided by the state information provision unit 21 of the terminal apparatus 2.

### (Step S12-2)

In step S12-2, the determination unit 12 of the information processing apparatus 1 determines an action with reference to the state which has been acquired in step S11-2 by the acquisition unit 11. Here, the determination unit 12 calculates a first function, which predicts a reward sum from a state and an action, by carrying out weighting for learning data and determines an action with use of the first function. Then, the information processing apparatus 1 provides, to the terminal apparatus 2, action information indicative of the determined action.

Here, in this step, used as the learning data to be referred to by the determination unit 12 to calculate the first function is, as an example, learning data having been accumulated until after step S13-1.

### (Step S22-2)

In step S22-2, the reward information provision unit 22 of the terminal apparatus 2 provides, to the information processing apparatus 1, reward information indicative of a reward obtained by executing the action which has been determined in step S12-2 by the determination unit 12 of the information processing apparatus 1.

### (Step S13-2)

In step S13-2, the accumulation unit 13 of the information processing apparatus 1 accumulates learning data that includes (i) the state which has been acquired in step S12-2 by the acquisition unit 11 and (ii) the reward obtained by the action which has been determined in step S12-2 by the determination unit 12.

### <Effect of Information Processing Method S100>

According to the information processing system 100 in accordance with the present example embodiment, a first function, which predicts a reward sum from a state and an action, is calculated by carrying out weighting for the learning data, and an action is determined with use of the first function. This makes it possible to determine a more suitable action.

### Second Example Embodiment

A second example embodiment of the present invention will be described in detail with reference to the drawings. The same reference numerals are given to constituent elements which have functions identical with those described in the first example embodiment, and descriptions as to such constituent elements are omitted as appropriate.

### <Configuration of Information Processing System 100A>

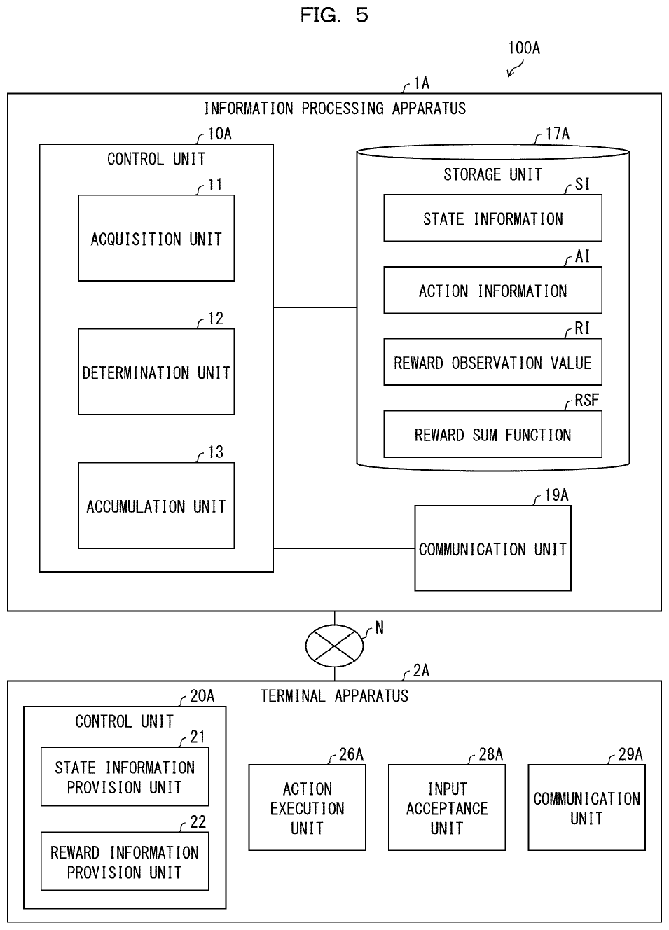

A configuration of an information processing system 100A in accordance with the present example embodiment will be described with reference to FIG. 5. FIG. 5 is a block diagram illustrating the configuration of the information processing system 100A. As illustrated in FIG. 5, the information processing system 100A includes an information processing apparatus 1A and a terminal apparatus 2A. In addition, as illustrated in FIG. 5, the information processing apparatus 1A and the terminal apparatus 2A are configured to be communicable to each other via a network N. Here, a specific configuration of the network N is not intended to limit the present example embodiment. As an example, it is possible to employ a wireless local area network (LAN), a wired LAN, a wide area network (WAN), a public network, a mobile data communication network, or a combination of these networks.

### <Configuration of Information Processing Apparatus 1A>

A configuration of an information processing apparatus 1A in accordance with the present example embodiment will be described with reference to FIG. 5. FIG. 5 is a block diagram illustrating the configuration of the information processing apparatus 1A.

As illustrated in FIG. 5, the information processing apparatus 1A includes a control unit 10A, a storage unit 17A, and a communication unit 19A.

The communication unit 19A communicates with an apparatus outside the information processing apparatus 1A. As an example, the communication unit 19A communicates with the terminal apparatus 2A. The communication unit 19A transmits, to the terminal apparatus 2A, data supplied from the control unit 10A and supplies, to the control unit 10A, data received from the terminal apparatus 2A.

### (Control Unit 10A)

The control unit 10A, as illustrated in FIG. 5, includes an acquisition unit 11, a determination unit 12, and an accumulation unit 13. The acquisition unit 11 is configured to realize an acquisition means in the present example embodiment. The determination unit 12 is configured to realize a determination means in the present example embodiment. The accumulation unit 13 is configured to realize an accumulation means in the present example embodiment.

The acquisition unit 11 acquires a state as in the first example embodiment. As an example, the acquisition unit 11 acquires state information that includes information pertaining to a state via the communication unit 19A from the state information provision unit 21 of the terminal apparatus 2A. Then, the acquisition unit 11 identifies the state indicated by the acquired state information. Note here that a specific example of the “state” is not intended to limit the present example embodiment. As an example of the “state”, a state of an environment such as a temperature and a weather condition can be taken as in the first example embodiment.

The determination unit 12 determines an action with reference to the state acquired by the acquisition unit 11, as in the first example embodiment. Here, the determination unit 12 calculates a first function, which predicts a reward sum from a state and an action, by carrying out weighting for learning data accumulated by the accumulation unit 13, and determines an action with use of the first function. Here, the first function is a function of predicting a reward sum as in the first example embodiment, and thus may also be referred to as a reward sum function. In addition, the first function is also a function of quantifying a value of an action and thus may also be referred to as an action value function. A specific example of the weighting processing which is carried out for the learning data by the determination unit 12 will be described later, and descriptions thereof are omitted here.

Note that a specific example of the “action” is not intended to limit the present example embodiment. As an example of the “action”, a “price” of a target object, a “purchase amount” thereof, and the like can be taken. Further, a specific example of the “reward” is not intended to limit the present example embodiment. As an example of the “reward”, “sales”, an “inverse of an inventory level”, a “difference obtained by subtracting the inventory level from a constant”, and the like on a target object can be taken.

The accumulation unit 13 accumulates learning data that includes (i) the state which has been acquired by the acquisition unit 11 and (ii) the reward obtained by the action which has been determined by the determination unit 12. As an example, the accumulation unit 13 stores, in the storage unit 17A, learning data that includes (i) the state which has been acquired by the acquisition unit 11 and (ii) the reward obtained by the action which has been determined by the determination unit 12.

The storage unit 17A stores various data to be referred to by the control unit 10A. As an example, the storage unit 17A, as illustrated in FIG. 5, stores state information SI, action information AI, a reward observation value RI, and a reward sum function RSF. The various data stored in the storage unit 17A will be described later with reference to a different drawing.

### <Configuration of Terminal Apparatus 2A>

The terminal apparatus 2A, as illustrated in FIG. 5, includes a control unit 20A, an action execution unit 26A, and input acceptance unit 28A, and a communication unit 29A. As an example, the terminal apparatus can be concretely realized as an accounting terminal located in a store, an inventory management terminal located in a warehouse, and the like. However, this is not intended to limit the present example embodiment.

The communication unit 29A communicates with an apparatus outside the terminal apparatus 2A. As an example, the communication unit 29A communicates with the information processing apparatus 1A. The communication unit 29A transmits, to the information processing apparatus 1A, data supplied from the control unit 20A and supplies, to the control unit 20A, data received from the information processing apparatus 1A.

The control unit 20A, as illustrated in FIG. 5, includes a state information provision unit 21 and a reward information provision unit 22.

The state information provision unit 21 acquires a state and provides the state to the information processing apparatus 1. As an example, the state information provision unit 21 accepts input of data indicative of a state via the input acceptance unit 28A and provides the data to the information processing apparatus 1.

The reward information provision unit 22 provides, to the information processing apparatus 1, reward information indicative of a reward obtained by executing an action which has been determined by the information processing apparatus 1. Here, the reward information provision unit 22 can be configured to acquire, via the input acceptance unit 28A, reward information indicative of a reward obtained by executing an action which has been determined by the information processing apparatus 1.

The action execution unit 26A executes an action which has been determined by the information processing apparatus 1. As an example, in a case where the action which has been determined by the information processing apparatus 1 is “setting a price of a target object to be a certain value”, the action execution unit 26A sets a price associated with the target object to be such a value. Further, in a case where the action which has been determined by the information processing apparatus 1 is “setting a purchase amount of a target object to be a certain value”, the action execution unit 26A sets a purchase amount associated with the target object to be such a value.

The input acceptance unit 28A accepts various inputs to the terminal apparatus 2A. A specific configuration of the input acceptance unit 28A is not intended to limit the present example embodiment. As an example, the input acceptance unit 28A can be configured to include an input device such as a keyboard and a touchpad. In addition, the input acceptance unit 28A may be configured to include, for example, a data scanner for reading data via electromagnetic waves, such as infrared rays and radio waves, and a sensor for sensing the state of the environment.

The input acceptance unit 28A acquires the above-described state information and the above-described reward information via, for example, the input device, the data scanner, and the sensor, which are described above, and supplies the acquired pieces of information to the control unit 20A. Here, the reward information acquired by the input acceptance unit 28A can include “sales” and “information related to an inventory level” on the target object.

### (Examples of Data Stored in Storage Unit 17A)

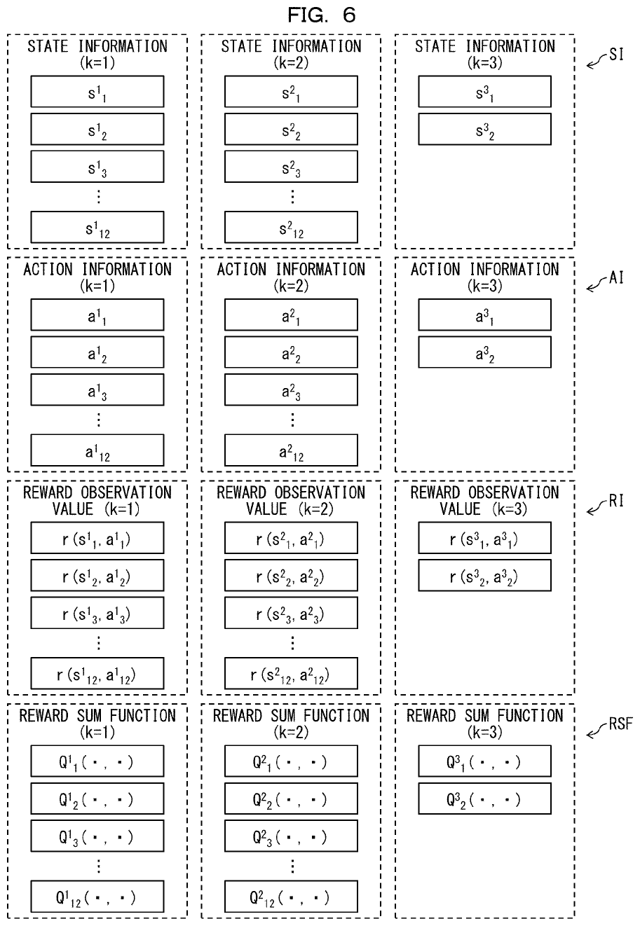

Next, various data stored in the storage unit 17A of the information processing apparatus 1A will be described with reference to FIG. 6.

As illustrated in FIG. 6, the storage unit 17A stores:
state information SI;
action information AI;
reward observation value RI; and
reward sum function RSF.

The state information SI, the action information AI, and the reward observation value RI constitute, as an example, the learning data to be referred to by the determination unit 12 in the present example embodiment.

### (State Information SI)

More specifically, the state information SI, as illustrated in FIG. 6, is represented by state parameters sₕ^{k} each having a first index k (k=1, 2, . . . K; K is a natural number) and a second index h (h=1, 2, . . . H; H is a natural number). Here, the following description will assume that the first index k is an index representing a date as an example. However, this is not intended to limit the present example embodiment. Further, the following description will assume that the second index h is an index representing a time period as an example. However, this is not intended to limit the present example embodiment.

As illustrated in FIG. 6, the state information SI includes, as an example, a state parameter group of s₁¹ to s₁₂¹ for k=1 and a state parameter group of s₁² to s₁₂² for k=2. In the example illustrated in FIG. 6, the state information SI includes a state parameter group of s₁³ and s₂³ for k=3.

A specific value of the state parameters sₕ^{k} included in the state information SI is acquired by the acquisition unit 11 and stored in the storage unit 17A. For example, as for a configuration in which a temperature is used as the state, used as each value of the state parameters sₕ^{k} is a numerical value of the temperature or a value obtained by converting the numerical value of the temperature by a predetermined conversion rule. Further, as for a configuration in which a weather condition is used as the state, used as each value of the state parameters sₕ^{k} is a value obtained by converting a weather condition into a numerical form. Note that the state parameters may be referred to simply as a state, unless any confusion arises.

### (Action Information AI)

Similarly, the action information AI, as illustrated in FIG. 6, is represented by action parameters aₕ^{k} each having the first index k and the second index h. As illustrated in FIG. 6, the action information AI includes, as an example, an action parameter group of a₁¹ to a₁₂¹ for k=1 and an action parameter group of a₁² to a₁₂² for k=2. Further, in the example illustrated in FIG. 6, the state information AI includes an action parameter group of a₁³ and a₂³ for k=3.

A specific value of the action parameters aₕ^{k} included in the action information AI is determined by the determination unit 12 and stored in the storage unit 17A. For example, as each value of the action parameters aₕ^{k}, a value indicating a “price” or a “purchase amount” is determined by the determination unit 12 and stored in the storage unit 17A. Note that the action parameters may be referred to simply as an action, unless any confusion arises.

### (Reward Observation Value RI)

The reward observation value RI is represented by the first index k and the second index k as illustrated in FIG. 6, and each value in the reward observation value RI is stored in the storage unit 17A. More specifically, the reward observation value RI obtained by executing an action aₕ^{k} under a state sₕ^{k} is expressed as r(sₕ^{k}, aₕ^{k}), and each value in the reward observation value RI is stored in the storage unit 17A, as illustrated in FIG. 6. As illustrated in FIG. 6, the reward observation value RI includes, as an example, a reward observation value group of r(s₁¹,a₁¹) to r(s₁₂¹,a₁₂¹) for k=1 and a reward observation value group of r(s₁², a₁²) to r(s₁₂², a₁₂²) for k=2. In the example illustrated in FIG. 6, the reward observation value RI includes an action parameter group reward observation value group of r(s₁³,a₁³) to r(s₂³,a₂³) for k=3.

Each value in r(sₕ^{k}, aₕ^{k}) included in the reward observation value RI is acquired by the acquisition unit 11, as an example, and stored in the storage unit 17A. For example, as each value in r(sₕ^{k}, aₕ^{k}), a numerical value representing “sales”, an “inverse of an inventory level”, a “difference obtained by subtracting the inventory level from a constant”, or the like on a target object is acquired by the acquisition unit 11 and stored in the storage unit 17A.

### (Reward Sum Function RSF)

As illustrated in FIG. 6, the storage unit 17A also stores each function form of the reward sum function RSF. Each function form of the reward sum function RSF is expressed as Qₕ^{k} with use of the first index k and the second index h. Qₕ^{k} is a function that receives input of two arguments and outputs a predicted value of a reward sum, and is also denoted as Qₕ^{k}(·,·). Here, the reward sum refers to, as an example, a sum total of rewards for a predetermined period of time. Two variables which Qₕ^{k} takes as the arguments are, as an example, a state and an action.

The reward sum function RSF may also be referred to as a reward sum function Q, a Q-function, or an action value function. Each function form of the reward sum function RSF is determined by the determination unit 12 and stored in the storage unit 17A.

### <Flow of Information Processing Method Carried Out by Information Processing Apparatus 1A>

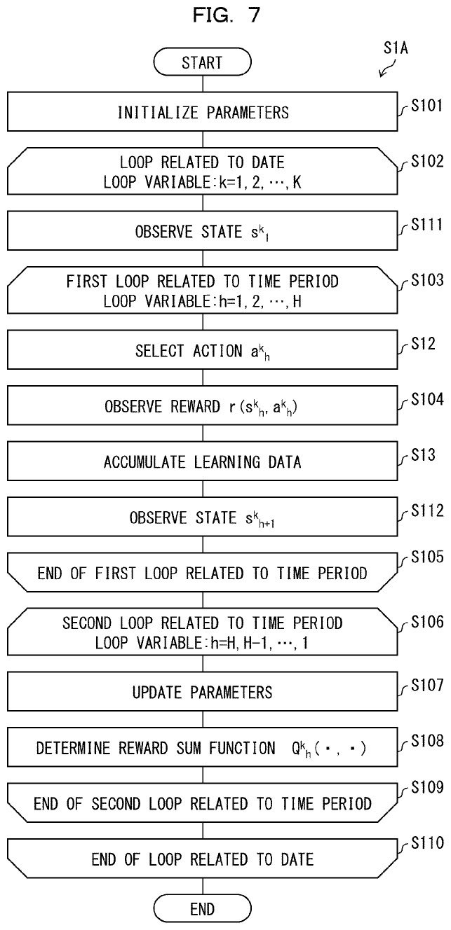

The flow of an information processing method S1A carried out by the information processing apparatus 1A configured as described above will be described with reference to FIG. 7. FIG. 7 is a flowchart illustrating the flow of the information processing method S1A. The information processing apparatus 1, by carrying out the information processing method S1A, repeatedly selects an action so as to maximize the following sum of reward observation values for a predetermined period of time:

$${\sum }_{k = 1}^{K} {\sum }_{h = 1}^{H} r ( {s}_{h}^{k} , {a}_{h}^{k} ) .$$

Note that descriptions of the contents that have already been described will be omitted.

In addition, in the following description, a set of states may be expressed as

[symbol]

,
and a set of actions may be expressed as [symbol]
.

### (Step S11)

In step S101, the determination unit 12 performs initialization of various parameters. As an example, the determination unit 12 acquires, via the acquisition unit 11, values to which parameters H and d are to be set, and sets the values of the parameters H and d to the acquired values.

Here, the parameter H is, as described earlier, a parameter that specifies the upper limit of the second index h. The parameter H can also be described as a total number of the second indexes h that can be taken for each value of the first index k.

On the other hand, the parameter d is a dimension of a vector that expresses a state and an action. In other words, there exists a mapping for representing a state and an action as a vector

$$ϕ : 𝒮 \times 𝒜 \to {ℝ}^{d} ,$$

and, as indicated by the expression above, the parameter d is a dimension of such a vector.

In step S101, the determination unit 12 further sets parameters Δ and β to, as an example,

$$λ = d / H$$

$$β = \sqrt{d} .$$

Note that at least one of the parameters d, H, λ, and β may also be referred to as a hyperparameter.

Further, in step S101, the determination unit 12 performs initialization processing as follows:

$${Λ}_{h}^{0} ← λ I for all h ∈ [ H ] .$$

$${\overline{Λ}}_{h}^{0} ← λ I for all h ∈ [ H ] .$$

$${b}_{h}^{0} ← 0 for all h ∈ [ H ] .$$

$${\hat{b}}_{h}^{0} ← 0 for all h ∈ [ H ] .$$

$${\tilde{b}}_{h}^{0} ← 0 for all h ∈ [ H ] .$$

$$Here ,$$

$${Λ}_{h}^{0}$$

$$and$$

$${\overline{Λ}}_{h}^{0}$$

are each a matrix, and

$${b}_{h}^{0} ,$$

$${\hat{b}}_{h}^{0} ,$$

$$and$$

$${\tilde{b}}_{h}^{0}$$

are each a vector. Further, the following expression:

$$[ H ]$$

represents a set of natural numbers from 1 to H.

Further, in step S101, the determination unit 12 initializes the Q-function as follows:

$${Q}_{h}^{0} ( \cdot , \cdot ) ← min \{ ( β / \sqrt{λ} ) {‖ ϕ ( \cdot , \cdot ) ‖}_{2} , H \} .$$

$$Here ,$$

$${‖ ϕ ( \cdot , \cdot ) ‖}_{2}$$

is obtained by applying, to a vector (may also referred to as a feature map) expressing a state and an action,

$$ϕ ( \cdot , \cdot )$$

an operation defined as follows:

$$∀ x ∈ {ℝ}^{d} , A ∈ {ℝ}^{d \times d} , {‖ x ‖}_{A} = \sqrt{{x}^{T} Ax} .$$

### (Step S102)

Step S102 is a start of a loop process which is related to a date and is performed by the determination unit 12. Here, a loop variable in the date-related loop process is as follows:

k=1, 2, . . . , K.

### (Step S111)

In step S111 in the loop related to a date, the determination unit 12 observes a state s₁^{k}. In other words, the determination unit 12 acquires a value of the state s₁^{k} via the acquisition unit 11.

### (Step S103)

Step S103 is a start of a first loop process which is related to a time period and is performed by the determination unit 12. Here, a loop variable in the time period-related loop process is as follows:

h=1, 2, . . . , H.

### (Step S12)

In step S12 in the first loop related to a time period, the determination unit 12 selects an action aₕ^{k}. As an example, the determination unit 12 selects the action aₕ^{k} expressed by the following mathematical expression:

$${a}_{h}^{k} ∈ {argmax}_{a ∈ 𝒜} {Q}_{h}^{k - 1} ( {s}_{h}^{k} , a ) \qquad ( Mathematical Expression A1 )$$

In other words, the determination unit 12 selects an action that maximizes the reward sum function which includes, as an argument, a state acquired by the acquisition unit 11.

### (Step S104)

Next, in step S104 in the first loop related to a time period, the determination unit 12 observes a reward r(sₕ^{k}, aₕ^{k}). In other words, the determination unit 12 acquires a value of the reward r(sₕ^{k}, aₕ^{k}) via the acquisition unit 11.

### (Step S13)

Next, in step S13 in the first loop related to a time period, the accumulation unit 13 causes learning data including the state sₕ^{k}, the action aₕ^{k}, and the reward r(sₕ^{k}, aₕ^{k}) to be stored in the storage unit 17A.

### (Step S112)

Next, in step S112 in the first loop related to a time period, the determination unit 12 observes a state sₕ₊₁^{k}. In other words, the determination unit 12 acquires a value of the state sₕ₊₁^{k} via the acquisition unit 11.

### (Step S105)

Step S105 is an end of the first loop process which is related to a time period and is performed by the determination unit 12.

### (Step S106)

Step S106 is a start of a second loop process which is related to a time period and is performed by the determination unit 12. A loop variable in this time period-related loop process is as follows:

h=H, H−1, . . . , 1.

Note that, before entering the second loop process related to a time period, the determination unit 12 may be configured to cause the Q-function to be initialized by the following:

$${Q}_{H + 1}^{k} ( \cdot , \cdot ) ← 0.$$

### (Step S107)

In step S107 in the second loop related to a time period, the determination unit 12 updates various parameters. More specifically, the determination unit 12 performs the following update process:

$${\overline{Λ}}_{h}^{k} ← {\overline{Λ}}_{h}^{k - 1} + ϕ ( {s}_{h}^{k} , {a}_{h}^{k} ) {ϕ ( {s}_{h}^{k} , {a}_{h}^{k} )}^{T} .$$

$${\hat{b}}_{h}^{k} ← {\hat{b}}_{h}^{k - 1} + ( {max}_{a ∈ 𝒜} {Q}_{h + 1}^{k} , ( {s}_{h + 1}^{k} , a ) ) ϕ ( {s}_{h}^{k} , {a}_{h}^{k} ) .$$

$${\tilde{b}}_{h}^{k} ← {\tilde{b}}_{h}^{k - 1} + {( {max}_{a ∈ 𝒜} {Q}_{h + 1}^{k} , ( {s}_{h + 1}^{k} , a ) )}^{2} ϕ ( {s}_{h}^{k} , {a}_{h}^{k} ) .$$

Then, with use of the parameters updated as described above,

$${\hat{w}}_{h}^{k} ← {( {\overline{Λ}}_{h}^{k} )}^{- 1} {\hat{b}}_{h}^{k} .$$

$${\tilde{w}}_{h}^{k} ← {( {\overline{Λ}}_{h}^{k} )}^{- 1} {\tilde{b}}_{h}^{k} .$$

is used to update values of the following vectors:

$${\hat{w}}_{h}^{k}$$

$$and$$

$${\tilde{w}}_{h}^{k} .$$

Further, in step S107, the determination unit 12 uses the following mathematical expression:

$${\overline{ℙ}}_{h} {V}_{h + 1}^{k} ( {s}_{h}^{k} , {a}_{h}^{k} ) ← max \{ min \{ 〈 ϕ ( {s}_{h}^{k} , {a}_{h}^{k} ) , {\hat{w}}_{h}^{k} 〉 , H \} , 0 \} \qquad ( Mathematical Expression A2 )$$

$${\overline{ℙ}}_{h} {( {V}_{h + 1}^{k} )}^{2} ( {s}_{h}^{k} , {a}_{h}^{k} ) ← max \{ min \{ 〈 ϕ ( {s}_{h}^{k} , {a}_{h}^{k} ) , {\tilde{w}}_{h}^{k} 〉 , H \} , 0 \} \\$$

$${\overline{σ}}_{h}^{k} ← \sqrt{max \{ {{\overline{ℙ}}_{h} ( {V}_{h + 1}^{k} )}^{2} ( {s}_{h}^{k} , {a}_{h}^{k} ) - {[ {\overline{ℙ}}_{h} {V}_{h + 1}^{k} ( {s}_{h}^{k} , {a}_{h}^{k} ) ]}^{2} , {H}^{2} / d \}} .$$

to update the following variance value:

$${\overline{σ}}_{h}^{k} .$$

Here, in the first and second lines in (Mathematical Expression A2), used is an inner product defined as follows:

$$∀ x , y ∈ {ℝ}^{d} , {x}^{T} y = 〈 x , y 〉 = {\sum }_{i = 1}^{d} {x}_{i} {y}_{i}$$

Further, in the third line in (Mathematical Expression A2),

$${\overline{ℙ}}_{h} {V}_{h + 1}^{k} ( {s}_{h}^{k} , {a}_{h}^{k} )$$

has a meaning as a mean of a state value function Vₕ₊₁^{k}(sₕ^{k}, aₕ^{k}) that includes, as arguments, the state sₕ^{k} and the action aₕ^{k}, and

$${{\overline{ℙ}}_{h} ( {V}_{h + 1}^{k} )}^{2} ( {s}_{h}^{k} , {a}_{h}^{k} )$$

has a meaning as a root mean square of the state value function Vₕ₊₁^{k}(sₕ^{k}, aₕ^{k}) that includes, as arguments, the state sₕ^{k} and the action aₕ^{k}. Therefore, the variance value

$${\overline{σ}}_{h}^{k}$$

determined as described above has a meaning as a variance of the state value function obtained with reference to the state sₕ^{k} and the action aₕ^{k}.

Further, in step S107, the determination unit 12 uses the following mathematical expression:

$$( Mathematical Expression A3 )$$

$${Λ}_{h}^{k} ← {Λ}_{h}^{k - 1} + {( 1 / {\overline{σ}}_{h}^{k} )}^{2} ϕ ( {s}_{h}^{k} , {a}_{h}^{k} ) {ϕ ( {s}_{h}^{k} , {a}_{h}^{k} )}^{⊤} .$$

$${b}_{h}^{k} ← {b}_{h}^{k - 1} + {( 1 / {\overline{σ}}_{h}^{k} )}^{2} ( r ( {s}_{h}^{k} , {a}_{h}^{k} ) + {max}_{a ∈ A} {Q}_{h + 1}^{k} ( {s}_{h + 1}^{k} , a ) ) ϕ ( {s}_{h}^{k} , {a}_{h}^{k} ) .$$

to update the matrix

$${Λ}_{h}^{k}$$

and the vector

$${b}_{h}^{k} .$$

Then, the matrix and vector updated as described above are used to update the vector

$${w}_{h}^{k}$$

by the following mathematical expression:

$${w}_{h}^{k} ← {( {Λ}_{h}^{k} )}^{- 1} {b}_{h}^{k} . \qquad ( Mathematical Expression A4 )$$

### (Step S108)

In step S108, the determination unit 12 determines the reward sum function Qₕ^{k}(·,·). More specifically, various parameters updated in step S107 are used to determine the reward sum function Qₕ^{k}(·,·) as expressed by the following mathematical expression:

$$( Mathematical Expression A5 )$$

$${Q}_{h}^{k} ( \cdot , \cdot ) ← max \{ min \{ {ϕ ( \cdot , \cdot )}^{⊤} {w}_{h}^{k} + β {‖ ϕ ( \cdot , \cdot ) ‖}_{{( {Λ}_{h}^{k} )}^{- 1}} , H \} , 0 \} .$$

### (Step S109)

Step S109 is an end of the second loop process which is related to a time period and is performed by the determination unit 12.

### (Step S110)

Step S110 is an end of the loop process which is related to a date and is performed by the determination unit 12.

### (Description of Details of Information Processing Method S1A)

The flow of the information processing method S1A has been described above, but can be described in more details as below.

First, as described above, the information processing method S1A includes, in a repeated manner, the following steps:
acquiring a state (steps S111 and S112);
determining an action with reference to the state (step S12); and
accumulating learning data including (i) the state and (ii) a reward obtained by the determined action (S13), and
in the step of determining the action (step S12), the action is determined with use of a first function, the first function predicting a reward sum from a state and an action and being calculated by carrying out weighting for learning data. Thus, according to the information processing method S1A, it is possible to determine a more suitable action.

Further, as described above with reference to (Mathematical Expression A1), the determination unit 12 selects an action that maximizes a reward sum function which includes, as an argument, a state acquired by the acquisition unit 11. Thus, it is possible to suitably select an action by which a reward observation value for a predetermined period of time becomes maximum.

Further, in the first and second lines in (Mathematical Expression A3), the factor expressed as

$${( 1 / {\overline{σ}}_{h}^{k} )}^{2}$$

is the square of the inverse of the variance value of the state evaluation function. Therefore, the first line in (Mathematical Expression A3) shows that the update process is carried out so that the larger the variance value of the state evaluation function, the smaller the contribution of the vector

$$ϕ ( {s}_{h}^{k} , {a}_{h}^{k} )$$

to the matrix

$${Λ}_{h}^{k} .$$

Further, the second line in (Mathematical Expression A3) shows that the update process is carried out so that the larger the variance value of the state evaluation function, the smaller the contribution of the reward r(sₕ^{k}, aₕ^{k}) for the vector

$${b}_{h}^{k} ,$$

the reward sum function, and the vector

$$ϕ ( {s}_{h}^{k} , {a}_{h}^{k} ) .$$

Therefore, the determination unit 12 which carries out the information processing method S1A is configured to: calculate the index related to the variability from one or more values included in the learning data; and calculate the reward sum function (also referred to as the first function) by applying a smaller weighting factor to the one or more values as the calculated index related to the variability is higher.

Further, as described earlier, the determination unit 12 calculates, as the index related to the variability, the variance of the state evaluation function (also referred to as the second function) obtained with reference to the state and the action.

Here, the variance of the state evaluation function can be interpreted as an index representing the reliability of each value included in the learning data. Thus, it can be interpreted that the larger the variability, the lower the reliability. Therefore, the determination unit 12 can also be expressed as the one that calculates the reward sum function by applying a higher weight to a value having higher reliability.

Thus, according to the above-described configuration, it is possible to suitably determine an action that maximizes the sum of reward observation values by taking in a larger contribution of learning data having higher reliability.

Further, as described above, the determination unit 12 calculates the reward sum function with use of the feature map:

$$ϕ ( \cdot , \cdot )$$

that maps a state and an action to a vector. In this way, the determination unit 12 calculates the reward observation function with use of the feature map that maps a state and an action to a vector. Thus, it is possible to suitably determine an action that maximizes a sum of reward observation values.

Although, in the above-described example, a variance value of a state evaluation function V has been taken as an example of the index related to variability. However, this is not intended to limit the present example embodiment. As the index related to variability, an index other than the variance value, such as a standard deviation of the state evaluation function V, may be used.

Note that, in a case where the information processing apparatus 1A is configured such that determination of the price of a target object is an action, the information processing apparatus 1A may be expressed as a price determination apparatus or a target object management apparatus. In a case where the information processing apparatus 1A is configured such that determination of the purchase amount of a target object is an action, the information processing apparatus 1A may be expressed as a purchase amount determination apparatus or an inventory management apparatus.

### Third Example Embodiment

A third example embodiment of the present invention will be described in detail with reference to the drawings. The same reference numerals are given to constituent elements which have functions identical with those described in the first and second example embodiments, and descriptions as to such constituent elements are omitted as appropriate.

### <Configuration of Information Processing Apparatus 1B>

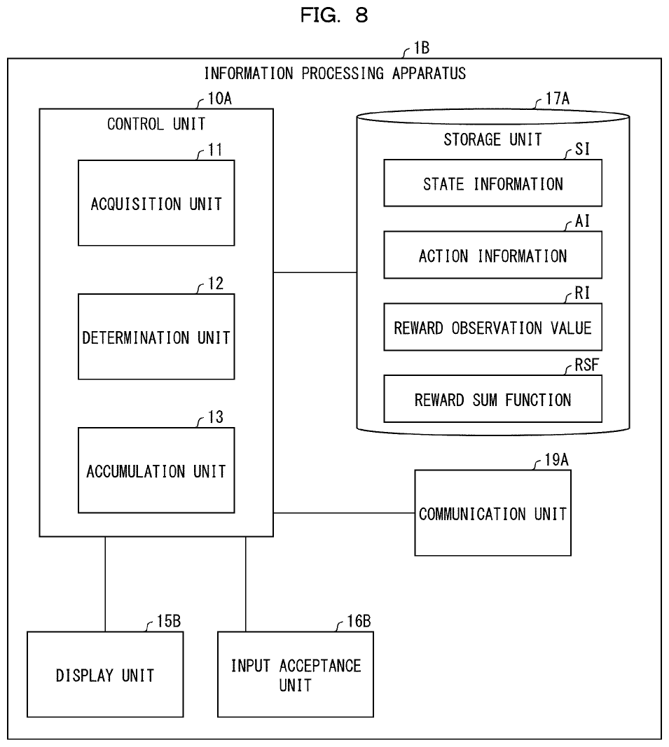

A configuration of an information processing apparatus 1B in accordance with the present example embodiment will be described with reference to FIG. 8. FIG. 8 is a block diagram illustrating the configuration of the information processing apparatus 1B.

As illustrated in FIG. 8, the information processing apparatus 1B includes, in addition to the components included in the information processing apparatus 1A in accordance with the example embodiment, a display unit 15B and an input acceptance unit 16B. The display unit 15B is configured to realize a display means in the present example embodiment. The input acceptance unit 16B is configured to realize an input acceptance means in the present example embodiment.

(Display unit 15B)

The display unit 15B is configured to be capable of displaying various data to be processed by the information processing apparatus 1B. The contents displayed by the display unit 15B are controlled by the control unit 10A. As an example, the display unit 15B is configured to include a display panel and a drive circuit for driving the display panel.

As an example, the display unit 15B displays at least one selected from the group consisting of the state sₕ^{k}, the action aₕ^{k}, the reward r(sₕ^{k}, aₕ^{k}), and a value of the reward sum function Q, together with the variance of the state evaluation function V.

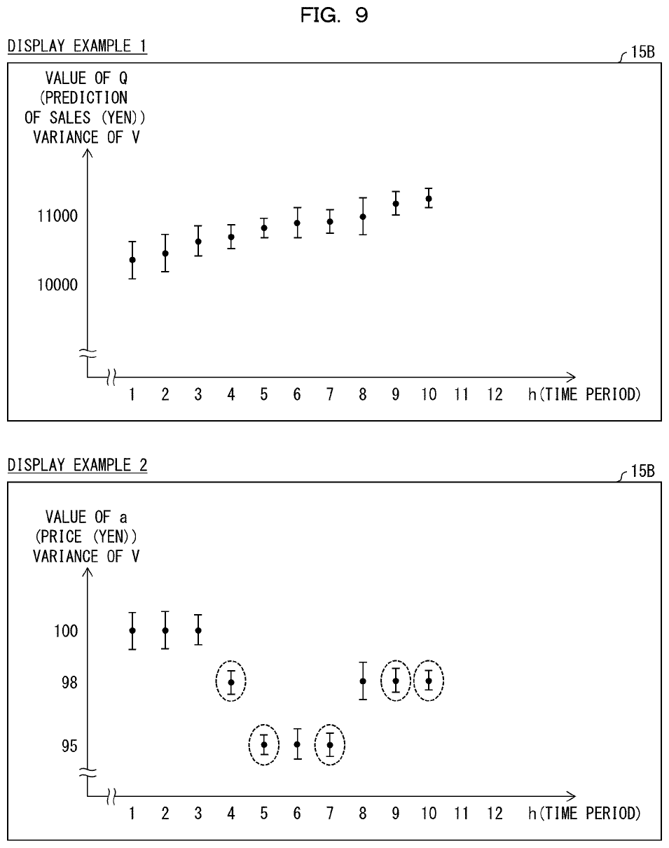

An upper view of FIG. 9 is a view illustrating an example of a display screen displayed by the display unit 15B. In the example illustrated in the upper view of FIG. 9, the display unit 15B displays, for each time period, a value of the reward sum function Q on a certain date and variance of the state evaluation function V corresponding thereto.

In the example illustrated in the upper view of FIG. 9, a black dot represents the value of the reward sum function Q, and a vertical bar represents the variance of the state evaluation function V.

Further, the display unit 15 may be configured, as an example, to display, in an emphasized manner, a value which is of at least one selected from the group consisting of the state sₕ^{k}, the action aₕ^{k}, the reward r(sₕ^{k}, aₕ^{k}), and a value of the reward sum function Q and which satisfies that the variance of the state evaluation function V corresponding to the value is equal to or less than a threshold value.

A lower view of FIG. 9 is a view illustrating an example of a display screen displayed by the display unit 15B. In the example illustrated in the lower view of FIG. 9, the display unit 15B displays, for each time period, a value (price) of the action a on a certain date and variance of the state evaluation function V corresponding thereto.

In the example illustrated in the lower view of FIG. 9, a black dot represents the value (price) of the action a, and a vertical bar represents the variance of the state evaluation function V. Further, the variance of the state evaluation function V can be interpreted as representing the reliability of each value of data, as described above.

Since the display unit 15B carries out the display as described above, the value of each data can be visually presented together with the reliability thereof to a user of the information processing apparatus 1B. Thus, usability and explainability of the information processing apparatus 1B are improved.

Further, in the example illustrated in the lower view of FIG. 9, a value satisfying that the variance of the state evaluation function V corresponding to the value is equal to or less than a threshold value is displayed in an emphasized manner. More specifically, display in an emphasized manner is carried out such that a black circle corresponding to a price which satisfies that the variance of the corresponding state evaluation function V is equal to or less than a threshold value and a bar corresponding thereto are displayed so as to be enclosed with a broken line.

Since the information processing apparatus 1B includes the display unit 15B as described above, the information processing apparatus 1B can visually present data which satisfies the variance of the state evaluation function V is equal to or less than a threshold value (in other words, the reliability is equal to or more than a threshold value) to the user of the information processing apparatus 1B. Thus, usability and explainability of the information processing apparatus 1B are further improved.

Note that, in the present example embodiment, the information processing apparatus 1B may be configured to include a recommendation value calculation unit that calculates a recommendation value of at least one of the parameters d, H, A, and B described in the second example embodiment and presents the calculated recommendation value to the user of the information processing apparatus 1B via the display unit 15B.

### (Input Acceptance Unit 16B)

The input acceptance unit 16B accepts various inputs to the information processing apparatus 1B. A specific configuration of the input acceptance unit 16B is not intended to limit the present example embodiment. As an example, the input acceptance unit 16B can be configured to include an input device such as a keyboard and a touchpad. In addition, the input acceptance unit 16B may be configured to include, for example, a data scanner for reading data via electromagnetic waves, such as infrared rays and radio waves, and a sensor for sensing the state of the environment.

The input acceptance unit 16B acquires the above-described state and reward observation value via, for example, the input device, the data scanner, and the sensor, which are described above, and supplies the acquired pieces of information to the control unit 10A.

Note that the information accepted by the input acceptance unit 16B is not limited to the above example. As an example, a configuration may be employed in which the input acceptance unit 16B accepts, from the user of the information processing apparatus 1B, correction information for correcting an action which has been determined by the determination unit 12. For example, a configuration may be employed in which, after the display unit 15B has carried out the display as described above, the user who has recognized the contents of the display inputs correction information for correcting the action (price) to the input acceptance unit 16B.

In the case of the configuration as described above, the determination unit 12 determines a post-correction action by correcting the action (price) which has been determined in step S12 in the second example embodiment by a correction amount indicated by the correction information. Then, the determination unit 12 observes a reward obtained by executing the post-correction action and executes the remaining processes which have been described in the second example embodiment.

According to the above-described configuration, a correction made by the user can be reflected to the action having been determined by the determination unit 12. Thus, it is possible to improve usability and explainability.

### (Application Example of Information Processing Apparatus 1B)

The following will describe one application example of the information processing apparatus 1B. The following application example is an example in which the information processing apparatus 1B is used to determine the price of beer of each company in a certain store. More specifically, a discount rate of beer of each company in a certain store is determined as an action (execution measure).

In this example, an execution measure X is expressed by a plurality of elements as follows:

$$X = [ 0 , 2 , 1 , … ] .$$

Here, it is assumed that a first element set to 0 indicates setting of a beer price of a company A to a fixed price, a second element set to 2 indicates a 10% increase in a beer price of a company B from a fixed price, and a third element set to 1 indicates a 10% reduction in a beer price of a company C from a fixed price.

As the reward sum function Q in this example, a configuration may be employed in which reward sum functions Q are prepared individually on sales of the beer of the company A, sales of the beer of the company B, and sales of the beer of the company C, and are updated individually. Alternatively, as the reward sum function Q, a configuration may be employed in which a reward sum function on total sales of the beer of the company A, the beer of the company B, and the beer of the company C is prepared and updated.

Further, in this example, the display unit 15B is used to visually present the sales of the beer of each company.

According to this application example, it is possible to derive a suitable price setting of the beer of each company in the store.

### [Software Implementation Example]

Some or all of functions of the information processing apparatuses 1, 1A, and 1B can be realized by hardware such as an integrated circuit (IC chip) or can be alternatively realized by software.

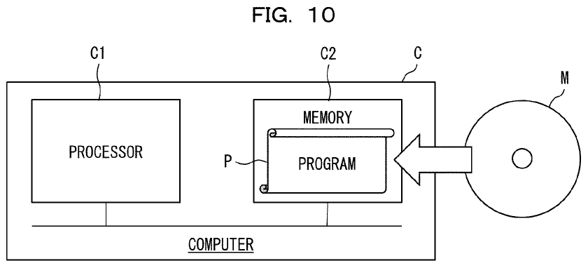

In the latter case, the information processing apparatuses 1, 1A, and 1B are each realized by, for example, a computer that executes instructions of a program that is software realizing the foregoing functions. FIG. 10 illustrates an example of such a computer (hereinafter, referred to as “computer C”). The computer C includes at least one processor C1 and at least one memory C2. The at least one memory C2 stores a program P for causing the computer C to operate as each of the information processing apparatuses 1, 1A, and 1B. In the computer C, the processor C1 reads the program P from the memory C2 and executes the program P, so that the functions of the information processing apparatuses 1, 1A, and 1B are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following example aspects.

### (Supplementary Note 1)

An information processing apparatus including: an acquisition means for acquiring a state; a determination means for determining an action with reference to the state; and an accumulation means for accumulating learning data including (i) the state and (ii) a reward obtained by the action which has been determined by the determination means, the determination means being configured to calculate a first function, which predicts a reward sum from a state and an action, by carrying out weighting for the learning data, and determine the action with use of the first function.

According to the above-described configuration, the first function, which predicts a reward sum from a state and an action, is calculated by carrying out weighting for the learning data, and an action is determined with use of the first function. This makes it possible to determine a more suitable action.

### (Supplementary Note 2)

The information processing apparatus according to supplementary note 11, wherein the determination means is configured to: calculate an index related to variability from one or more values included in the learning data; and calculate the first function by applying a smaller weighting factor to the one or more values as the calculated index related to the variability is higher.

According to the above-described configuration, the first function is calculated by applying a smaller weighting factor to the one or more values as the index related to the variability is higher. This makes it possible to determine a more suitable action.

### (Supplementary Note 3)

The information processing apparatus according to supplementary note 2, wherein the determination means is configured to calculate variance of a second function as the index related to the variability, the variance of the second function being obtained with reference to the state and the action.

According to the above-described configuration, the variance of the second function, which is obtained with reference to the state and the action, is calculated as the index related to the variability. This makes it possible to determine a more suitable action.

### (Supplementary Note 4)

The information processing apparatus according to supplementary note 2 or 3, including a display means for displaying (i) at least one selected from the group consisting of the state, the action, the reward, and a value of the first function and (ii) the index related to the variability.

According to the above-described configuration, usability and explainability are improved.

### (Supplementary Note 5)

The information processing apparatus according to supplementary note 4, wherein the display means is configured to display, in an emphasized manner, a value which is of the at least one selected from the state, the action, the reward, and the value of the first function and which satisfies that the index related to the variability is equal to or less than a threshold value.

According to the above-described configuration, usability and explainability are improved.

### (Supplementary Note 6)

The information processing apparatus according to any one of supplementary notes 1 to 5, wherein the determination means is configured to calculate the first function with use of a feature map that maps the state and the action to a vector.

According to the above-described configuration, it is possible to determine a more suitable action.

### (Supplementary Note 7)

The information processing apparatus according to any one of supplementary notes 1 to 6, wherein the determination means is configured to select an action that maximizes the first function which includes, as an argument, the state acquired by the acquisition means.

According to the above-described configuration, an action is selected that maximizes the first function which includes, as an argument, the state acquired by the acquisition means. Thus, it is possible to suitably select an action by which a reward observation value for a predetermined period of time becomes maximum.

### (Supplementary Note 8)

The information processing apparatus according to any one of supplementary notes 1 to 7, further including an input device configured to accept the state and the reward.

According to the above-described configuration, it is possible to suitably input the state and the reward via the input device.

### (Supplementary Note 9)

An information processing method including, in a repeated manner, the steps of: an information processing apparatus acquiring a state; the information processing apparatus determining an action with reference to the state; and the information processing apparatus accumulating learning data including (i) the state and (ii) a reward obtained by the determined action, wherein, in the step of determining the action, the action is determined with use of a first function, the first function predicting a reward sum from a state and an action and being calculated by carrying out weighting for the learning data.

The above-described method brings about an effect that is similar to the effect brought about by the information processing apparatus described above.

### (Supplementary Note 10)

A program causing a computer to function as an information processing apparatus, the program causing the computer to function as: an acquisition means for acquiring a state; a determination means for determining an action with reference to the state; and an accumulation means for accumulating learning data including (i) the state and (ii) a reward obtained by the action which has been determined by the determination means, the determination means being configured to calculate a first function, which predicts a reward sum from a state and an action, by carrying out weighting for the learning data, and determine the action with use of the first function.

The above-described program brings about an effect that is similar to the effect brought about by the information processing apparatus described above.

### (Supplementary Note 11)

An information processing system including an information processing apparatus and a terminal apparatus, wherein the information processing apparatus includes: an acquisition means for acquiring a state; a determination means for determining an action with reference to the state; and an accumulation means for accumulating learning data including (i) the state and (ii) a reward obtained by the action which has been determined by the determination means, the determination means being configured to calculate a first function, which predicts a reward sum from a state and an action, by carrying out weighting for the learning data, and determine the action with use of the first function, and the terminal apparatus includes: a state information provision means for acquiring a state and providing the state to the information processing apparatus; and a reward information provision means for providing, to the information processing apparatus, reward information indicative of a reward obtained by executing an action which has been determined by the information processing apparatus.

The above-described information processing system brings about an effect that is similar to the effect brought about by the information processing apparatus described above.

### (Supplementary Note 12)

An information processing method including, in a repeated manner, the steps of: an information processing apparatus acquiring a state; the information processing apparatus determining an action with reference to the state; and the information processing apparatus accumulating learning data including (i) the state and (ii) a reward obtained by the determined action, wherein, in the step of determining the action, the action is determined with use of a first function, the first function predicting a reward sum from a state and an action and being calculated by carrying out weighting for the learning data; a terminal device acquiring a state and providing the state to the information processing apparatus; and the terminal device providing, to the information processing apparatus, reward information indicative of a reward obtained by executing an action which has been determined by the information processing apparatus.

The above-described information processing method brings about an effect that is similar to the effect brought about by the information processing apparatus described above.

### [Additional Remark 3]

Furthermore, some of or all of the foregoing example embodiments can also be described as below.

Provided is at least one processor, the at least one processor carrying out: an acquisition process of acquiring a state; a determination process of determining an action with reference to the state; and an accumulation process of accumulating learning data including (i) the state and (ii) a reward obtained by the action which has been determined in the determination process, the processor calculating a first function, which predicts a reward sum from a state and an action, by carrying out weighting for the learning data, and determining the action with use of the first function.

Note that the information processing apparatus can further include a memory. The memory can store a program for causing the processor to execute the acquisition process, the determination process, and the accumulation process. The program can be stored in a computer-readable non-transitory tangible storage medium.

### REFERENCE SIGNS LIST

1, 1A, 1B information processing apparatus
11 acquisition unit
12 determination unit
13 accumulation unit
15B display unit
16B input acceptance unit
17A storage unit
100, 100A information processing system

What is claimed is:

1. An information processing apparatus: comprising
at least one processor, the at least one processor carrying out:
an acquisition process of acquiring a state;
a determination process of determining an action with reference to the state; and
an accumulation process of accumulating learning data including (i) the state and (ii) a reward obtained by the action which has been determined in the determination process,
in the determination process, the at least one processor calculating a first function, which predicts a reward sum from a state and an action, by carrying out weighting for the learning data, and determining the action with use of the first function.

2. The information processing apparatus according to claim 1, wherein, in the determination process, the at least one processor: calculates an index related to variability from one or more values included in the learning data, and
calculates the first function by applying a smaller weighting factor to the one or more values as the calculated index related to the variability is higher.

3. The information processing apparatus according to claim 2, wherein, in the determination process, the at least one processor calculates variance of a second function as the index related to the variability, the variance of the second function being obtained with reference to the state and the action.

4. The information processing apparatus according to claim 2, wherein the at least one processor further carries out a display process of displaying (i) at least one selected from the group consisting of the state, the action, the reward, and a value of the first function and (ii) the index related to the variability.

5. The information processing apparatus according to claim 4, wherein, in the display process, the at least one processor displays, in an emphasized manner, a value which is of the at least one selected from the state, the action, the reward, and the value of the first function and which satisfies that the index related to the variability is equal to or less than a threshold value.

6. The information processing apparatus according to claim 1, wherein, in the determination process, the at least one processor calculates the first function with use of a feature map that maps the state and the action to a vector.

7. The information processing apparatus according to claim 1, wherein, in the determination process, the at least one processor selects an action that maximizes the first function which includes, as an argument, the state acquired in the acquisition process.

8. The information processing apparatus according to claim 1, further comprising an input device configured to accept the state and the reward.

9. An information processing method comprising, in a repeated manner, the steps of:
an information processing apparatus acquiring a state;
the information processing apparatus determining an action with reference to the state; and
the information processing apparatus accumulating learning data including (i) the state and (ii) a reward obtained by the determined action,
wherein, in the step of determining the action, the action is determined with use of a first function, the first function predicting a reward sum from a state and an action and being calculated by carrying out weighting for the learning data.

10. A computer-readable non-transitory storage medium storing a program causing a computer to function as the information processing, apparatus according to claim 1,
the program causing the computer to carry out the acquisition process, the determination process, and the accumulation process.

11. An information processing system comprising an information processing apparatus and a terminal apparatus, wherein
the information processing apparatus comprises at least one processor, the at least one processor carrying out:
an acquisition process of acquiring a state;
a determination process of determining an action with reference to the state; and
an accumulation process of accumulating learning data including (i) the state and (ii) a reward obtained by the action which has been determined in the determination process,
in the determination process, the at least one processor calculating a first function, which predicts a reward sum from a state and an action, by carrying out weighting for the learning data, and determining the action with use of the first function, and
the terminal apparatus comprises at least one processor, the at least one processor of the terminal apparatus carrying out:
a state information provision process of acquiring a state and providing the state to the information processing apparatus; and
a reward information provision process of providing, to the information processing apparatus, reward information indicative of a reward obtained by executing an action which has been determined by the information processing apparatus.

12. (canceled)
